(19) United States
(12) Patent Application Publication
(10) Pub. No.: US 2016/0219559 A1
(43) Pub. Date: Jul. 28, 2016

(54) METHOD AND APPARATUS FOR TRANSMITTING CONTROL INFORMATION AND STATUS INFORMATION OF BASE STATION

(71) Applicant: Electronics and Telecommunications Research Institute, Daejeon (KR)

(72) Inventors: Kyung Yeol SOHN, Daejeon (KR); Youn Ok PARK, Daejeon (KR)

(21) Appl. No.: 15/005,138

(22) Filed: Jan. 25, 2016

(30) Foreign Application Priority Data
Jan. 26, 2015 (KR) 10-2015-0012383

(51) Int. Cl. H04W 72/04

(52) U.S. Cl. CPC H04W 72/042

(57) ABSTRACT

Disclosed are a method and an apparatus for transmitting control information and status information. In a distributed base station where a digital unit and a radio unit transmit/receive a signal through an optical transceiver, the digital unit inserts control information for controlling the radio unit into a guard band of a downlink transmission signal to be transmitted through an antenna. The radio unit inserts status information into a guard band of an uplink reception signal received through the antenna and to transmit an uplink reception signal including the status information to the digital unit.

### CROSS-REFERENCE TO RELATED APPLICATION

This application claims priority to and the benefit of Korean Patent Application No. 10-2015-0012383 filed in the Korean Intellectual Property Office on Jan. 26, 2015, the entire contents of which are incorporated herein by reference.

### BACKGROUND OF THE INVENTION

(a) Field of the Invention

The present invention relates to a method and an apparatus for transmitting control information and status information.

(b) Description of the Related Art

In a next generation multimedia communication system which is actively being studied, researches and studies have been performed regarding a distributed base station being advantageous that an installation cost of the base station may be reduced as compared with a base station according to the related art, it is easy to manage the base station, and the distributed base station is environmentally friendly.

The distributed base station represents a system including a digital unit (DU) configured to process a digital signal and a radio unit (RU) physically separated from the DU to process a wireless signal, and may refer to a Remote Radio Head (RRH). The distributed base station transfers a downlink transmission signal to an RU from the DU using a Radio over Fiber (RoF)-based optical cable, and transfers an uplink reception signal to the DU from the RoF.

In recent years, as a technology using a concentrated digital unit (DU) in the distributed base station has been developed, a plurality of digital units (DUs) are disposed at a local station of a corporation and there is a great need to require connection of a high number of RUs using one optical cable, so that a technology for allocating a plurality of intermediate frequency (IF) bands to one optical wavelength and allocating a transmission signal to each IF band has been developed. Accordingly, the DU should transfer control information for controlling the RU to periodically collect status information which is currently maintained from RUs. To this end, the distributed base station transfers control information or status information between the DU and the RU using a different band from an IF band to transmit transmission/reception signals or a guard band different from the IF band to transmit the transmission/reception signal.

However, in order to transmit the control information or the status information, when a separate band is allocated, a usable resource is consumed and consumption of the resource is increased if the number of DUs and RUs is increased. Further, when a different guard band from the IF band is used to transmit the transmission/reception signal, a width of the guard band is not wide so that the control information or status information should be extracted using a very sophisticated band filter.

### SUMMARY OF THE INVENTION

The present invention has been made in an effort to provide a method and an apparatus for transmitting control information and status information having advantages of efficiently transmitting control information and status information between a digital unit and a radio unit in a distributed base station. An exemplary embodiment of the present invention provides a method of transmitting control information by a distributed base station where a digital unit and a radio unit transmit/receive a signal through an optical transceiver, the method including: inserting control information for controlling the radio unit into a guard band of a downlink transmission signal to be transmitted through an antenna by the digital unit; and transmitting the downlink transmission signal including the control information to the radio unit through the optical transceiver by the digital unit.

The inserting of the control information may include: allocating the control information to a preset sub-carrier of a guard band of the downlink transmission signal to process inverse fast Fourier transform (IFFT); and performing a superposition operation between the IFFT processed signal and the downlink transmission signal by sub-carriers.

The method may further include: receiving the downlink transmission signal including the control information through the optical transceiver by the radio unit; and extracting the control information of the guard band from the received downlink transmission signal.

The digital unit and the radio unit may transmit/receive an intermediate frequency (IF) band signal through the optical transceiver, and are connected to each other based on Radio over Fiber (RoF).

Another embodiment of the present invention provides a method of transmitting status information by a distributed base station where a digital unit and a radio unit transmit/receive a signal through an optical transceiver, the method including: inserting status information on the radio unit into a guard band of a uplink reception signal to be received through an antenna by the radio unit; and transmitting the uplink reception signal including the status information to the digital unit through the optical transceiver.

The inserting of the status information may include: detecting symbol timing from the uplink reception signal; allocating status information to a preset sub-carrier of a guard band of the uplink reception signal based on the symbol timing to process IFFT; and performing a superposition operation between the IFFT processed signal and the uplink reception signal by sub-carriers.

The method may further include: receiving the uplink reception signal including the status information through the optical transceiver; and extracting the status information of the guard band from the received uplink signal.

Yet another embodiment of the present invention provides an apparatus for transmitting control information by a distributed base station where a digital unit and a radio unit transmit/receive a signal through an optical transceiver, the apparatus including: a control information insertion unit configured to insert control information for controlling the radio unit into a preset sub-carrier of a guard band of a downlink transmission signal to be transmitted through an antenna; and an IF converter configured to convert the downlink transmission signal including the control information to an IF signal and to transmit to the radio unit through the optical transceiver.

The control information insertion unit may include: a control information allocation unit configured to allocate the control information to a preset sub-carrier of the guard band of the downlink transmission signal; an IFFT unit configured to process inverse fast Fourier transform (IFFT) for a signal to which the control information is allocated; and an adder which performs a superposition operation between the IFFT processed signal and the downlink transmission signal by sub-carriers to output the superposition result to the IF converter.

The IF converter may convert the IF band signal received from the optical transceiver into a baseband signal to output the baseband signal. In this case, the apparatus for controlling the control information may further include a status information extractor configured to extract status information on the radio unit from a guard band of a baseband output from the IF converter.

The status information extractor may include: a fast Fourier transform (FFT) unit configured to process FFT with respect to the baseband signal output from the IF converter; a received signal extractor configured to extract an uplink reception signal from the FFT processed signal; and an information extractor configured to extract the status information from the guard band of the FFT processed signal.

The apparatus for transmitting control information may be included in the digital unit.

Yet another embodiment of the present invention provides an apparatus for transmitting status information by a distributed base station where a digital unit and a radio unit transmit/receive a signal through an optical transceiver, the apparatus including: a radio frequency (RF) converter configured to process and output an uplink reception signal received through an antenna; a status information insertion unit configured to insert status information on the radio unit into a preset sub-carrier of a guard band of an uplink reception signal in the RF converter; and a first intermediate frequency (IF) converter configured to convert the uplink reception signal including the status information into an IF band signal.

The apparatus may further include: a second IF converter which converts an uplink reception signal of an IF band output from the RF converter into a baseband signal to output the baseband signal; and a timing detector configured to detect symbol timing from the baseband signal output from the second IF converter, wherein the status information insertion unit may insert the status information into a guard band of the baseband signal output from the second IF converter according to the detected symbol timing.

The status information insertion unit may include: a status information allocation unit configured to allocate the status information to a preset sub-carrier of a guard band of the baseband signal output from the second IF converter; an IFFT unit to process inverse fast Fourier transform (IFFT) with respect to a signal to which the status information is allocated; and an adder which overlaps the IFFT processed signal with the downlink transmission signal of a baseband signal output from the second IF converter by sub-carriers to output the overlapping result to the first IF converter.

The apparatus may further include a control information extractor configured to extract control information of the digital unit from a downlink transmission signal received through the optical transceiver. In this case, the first IF converter may convert a downlink transmission signal of an IF band received from the optical transceiver into a baseband signal to transmit the baseband signal to the control information extractor, and the second IF converter may convert a downlink transmission signal from which the control information is extracted by the control information extractor into an IF band signal to transmit the IF band signal to the RF converter.

The control information extractor may include: a fast Fourier transform (FFT) unit configured to process FFT with respect to the baseband signal output from the first IF converter; a transmission signal extractor configured to extract a downlink transmission signal from the FFT processed signal; and an information extractor configured to extract the control information from the guard band of the FFT processed signal.

The apparatus for transmitting status information may be included in the radio unit.

### BRIEF DESCRIPTION OF THE DRAWINGS

FIG. 1 is a block diagram illustrating a configuration of a base station according to an exemplary embodiment of the present invention.

FIG. 2 is a diagram illustrating frequency bandwidth allocation for control information and status information according to an exemplary embodiment of the present invention.

FIG. 3 is a diagram illustrating a configuration of an apparatus for transmitting control information according to an exemplary embodiment of the present invention.

FIG. 4 is a block diagram illustrating a configuration of a control information insertion unit according to an exemplary embodiment of the present invention.

FIG. 5 is a block diagram illustrating a configuration of a state information extractor according to an exemplary embodiment of the present invention.

FIG. 6 is a block diagram illustrating a configuration of an apparatus for transmitting state information according to an exemplary embodiment of the present invention.

FIG. 7 is a block diagram illustrating a configuration of a control information extractor according to an exemplary embodiment of the present invention.

FIG. 8 is a block diagram illustrating a configuration of a state information insertion unit according to an exemplary embodiment of the present invention.

FIG. 9 is a flowchart illustrating a method of transmitting control information according to an exemplary embodiment of the present invention.

FIG. 10 is a flowchart illustrating a method of transmitting status information according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

Hereinafter, a method and an apparatus for transmitting control information and status information according to an exemplary embodiment of the present invention will be described.

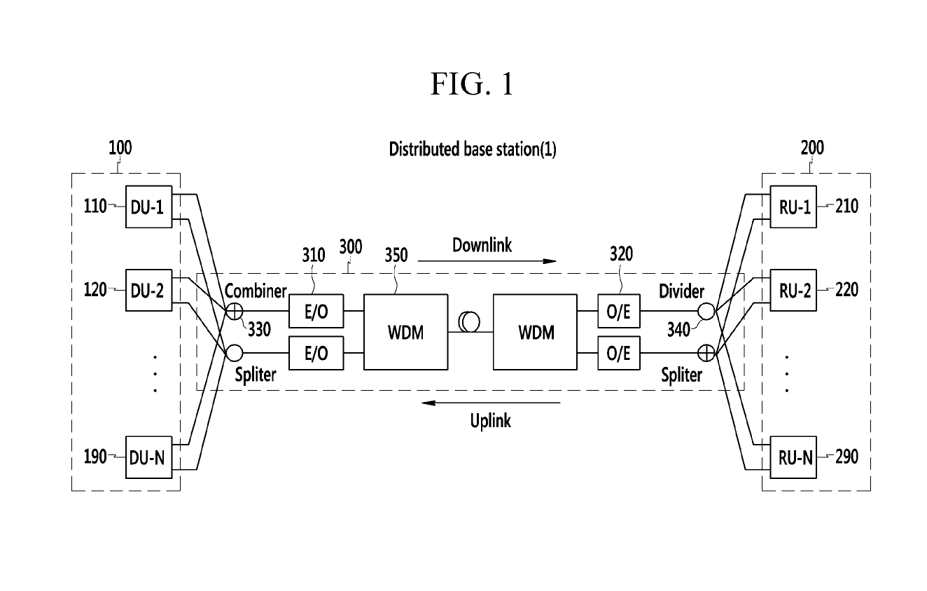

FIG. 1 is a block diagram illustrating a configuration of a base station according to an exemplary embodiment of the present invention.

As shown in FIG. 1, a base station 1 according to an exemplary embodiment of the present invention includes a digital signal processor 100 and a wireless signal processor 200. The digital signal processor 100 is separated from a wireless signal processor 200 by an optical transceiver 300 based on a Radio over Fiber (RoF).

The digital signal processor 100 includes a plurality of digital units 110, 120, . . . , 190, and the wireless signal processor 200 includes a plurality of radio units 210, 220, . . . , and 290.

The optical transceiver 300 functions as a link to exchange an uplink signal and a downlink signal between the digital signal processor 100 and the wireless signal processor 200. In a system using a general FDD (frequency division duplex) scheme, one optical wavelength is allocated at a downlink and another optical wavelength is allocated at an uplink. In a system using a time division duplex (TDD) scheme, one optical wavelength is time-divided and used. Alternatively, in order to reduce interference between uplink/downlink signals, different optical wavelengths are allocated as in an FDD type system. In order to distinguish this, a wavelength distributed multiplexing (WDM) optical device may be added or used.

As shown in FIG. 1, the optical transceiver 300 includes an electrical-to-optical (E/O) converter 310, an optical-to-electrical (O/E) converter 320, a combiner 330, a splitter 340, and an optical device 350.

The E/O converter 310 converts an electric signal into an optical signal, and the O/E converter 320 converts an optical signal into an electrical signal.

The combiner 330 combines signals input from a plurality of digital units or signals input from a plurality of radio units with each other.

The splitter 340 splits a signal received from the E/O converter 310 to a plurality of digital units. Further, the splitter 340 splits the signal received from the O/E converter 320 to a plurality of radio units.

The optical device 350 includes a Wavelength Distributed Multiplexing (WDM) optical device which transmits an optical wavelength for transmitting a downlink signal and an optical wavelength for receiving an uplink signal through one optical fiber.

In a distributed base station according to an exemplary embodiment of the present invention having the above configuration, the control information and the state information are transmitted as follows.

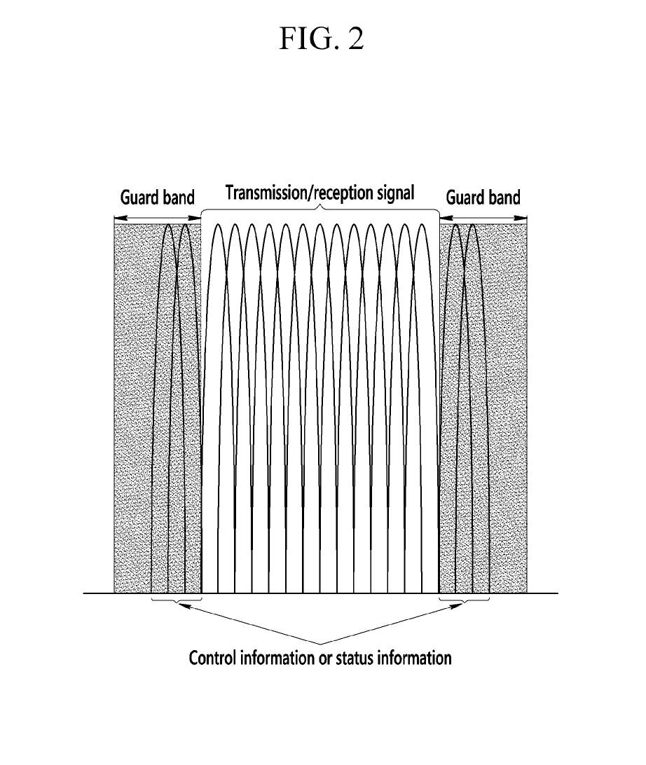

FIG. 2 is a diagram illustrating frequency bandwidth allocation for control information and status information according to an exemplary embodiment of the present invention.

Digital units 110, 120, . . . , and 190 transfer control information for controlling radio units 210, 220, . . . , and 290 to the radio unit to periodically collect status information which is currently maintained from the radio units. A guard band is used so as to exchange the control information and the state information.

In a system such as LTE (long term evolution) or WiMax-Adv. using an orthogonal frequency division multiplexing (OFDM) scheme, a generally used carrier band is divided into at least one sub-carrier. In order to prevent interference between a used-band to be used for a signal to be transmitted/received through an antenna and an adjacent used-band from being generated, a guard-band is disposed. For example, when a WiMax-Adv. system uses a 20 MHz band, an entire band is divided into 2048 sub-channels, where (0-159)-th sub-carriers and (1889-2047)-th sub-carriers are used as a guard band. Further, in a case of a LTE-Adv. System, among 2048 sub-carriers, 847 sub-carriers are used as a guard band.

Since the guard band is a null region through which no data are transmitted, in an exemplary embodiment of the present invention, as shown in FIG. 2, in order to exchange control information and state information between a digital unit and a radio unit of a RoF-based distributed base station, a sub-carrier of the guard band is used.

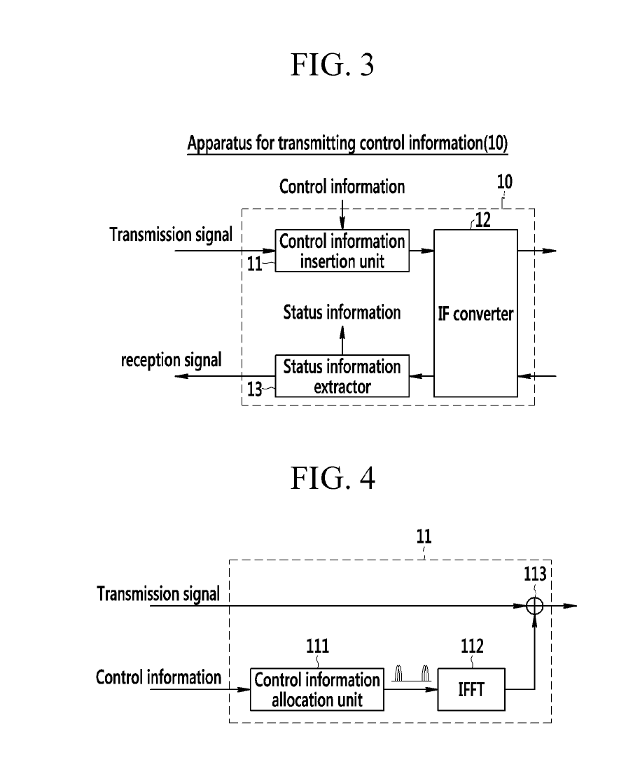

FIG. 3 is a diagram illustrating a configuration of an apparatus for transmitting control information according to an exemplary embodiment of the present invention.

The control information transmitter 10 according to an exemplary embodiment of the present invention is implemented to be included in a digital unit of the distributed base station, and processes control information to transmit the processed control information to the radio unit.

For the purpose, as shown in FIG. 3, the control information transmitter 10 includes a control information insertion unit 11, an intermediate frequency (IF) converter 12, and a status information extractor 13. Each digital unit 110, 120, . . . , or 190 allocates a downlink transmission signal transmitted through an antenna to a preset sub-carrier, and the control information insertion unit 11 inserts control information on the radio unit into a downlink transmission signal. That is, control information transmitted for control of each radio unit 210, 220, . . . , 290 is inserted into a preset sub-carrier of a guard band having a baseband.

The IF converter 12 converts a baseband signal output from the control information insertion unit 11 into a preset IF band signal to transfer the preset IF band signal to the optical transceiver 300, and converts the preset IF band signal received from the optical transceiver 300 into a baseband signal to output the baseband signal. In order to uplink-convert the baseband signal into an IF band signal, the IF converter 12 may include an IF frequency oscillator, a frequency mixer, and a band-pass filter. Further, so as to convert the IF band signal into the baseband signal, the IF converter 12 may further include a frequency mixer, a band-pass filter, and a low pass filter.

The status information extractor 13 extracts an uplink reception signal received through an antenna allocated to a preset sub-carrier from the baseband signal output from the IF converter 12. Further, the status information extractor 13 extracts the status information transmitted from radio units 210, 220, . . . , and 290 from a preset sub-carrier of a guard band.

Meanwhile, the control information insertion unit 11 of the control information transmitter 10 in the digital unit having the above configuration may have the construction as illustrated in FIG. 4.

FIG. 4 is a block diagram illustrating a configuration of a control information insertion unit according to an exemplary embodiment of the present invention.

As shown in FIG. 4, the control information insertion unit 11 includes a control information allocation unit 111, an inverse fast Fourier transform (IFFT) unit 112, and an adder 113.

The control information allocation unit 111 allocates control information used in control of the radio unit from the digital unit to a preset sub-carrier of a guard band, and provides the sub-carrier to the IFFT unit 112.

The IFFT unit 112 processes an IFFT with respect to a signal provided from the control information allocation unit 111. In this case, the IFFT processed signal by the IFFT unit 112 is provided to the adder 113.

The adder 113 performs a superposition operation between a downlink transmission signal to be transmitted through the antenna and a signal output from the IFFT unit by sub-carriers. In this case, the downlink transmission signal transmitted through the antenna corresponds to a signal of the IFFT processed time domain, and a signal superpositioned by the adder 113 is provided to the IF converter 12.

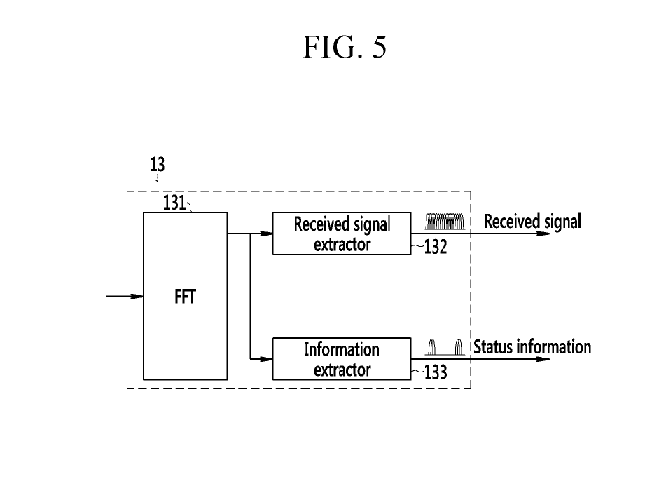

Meanwhile, the information extractor 11 of the control information transmitter 10 of the digital unit may have a configuration as illustrated in FIG. 5.

FIG. 5 is a block diagram illustrating a configuration of a state information extractor according to an exemplary embodiment of the present invention.

As shown in FIG. 5, the status information extractor 13 includes an FFT unit 131, a received signal extractor 132, and an information extractor 133.

The FFT unit 131 performs fast Fourier transform (FFT) on a signal provided from the IF converter 12. In this case, the FFT signal from the FFT unit 131 is provided to the received signal extractor 132 and the information extractor 133.

The received signal extractor 132 extracts an uplink reception signal from the preset sub-carrier through the antenna. Further, the received signal extractor 132 may extract a received signal by inserting a “zero” value or a “null” value into a sub-carrier of a guard band allocated to the status information.

The information extractor 133 extracts the inserted status information from the preset sub-carrier of a guard band in order to report the state of the radio unit to the digital unit.

A status information transmitter of a radio unit for transmitting and receiving information to a digital unit of a RoF-based distributed base station has a following configuration.

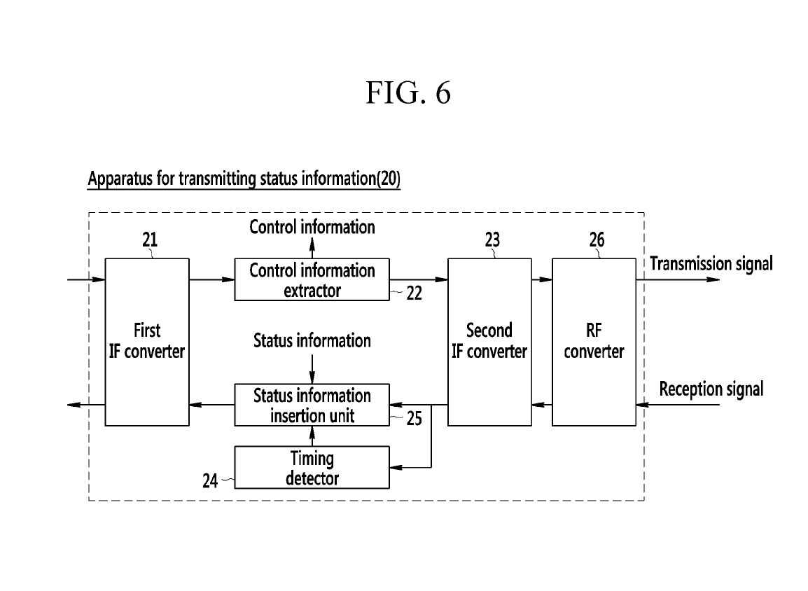

FIG. 6 is a block diagram illustrating a configuration of an apparatus for transmitting state information according to an exemplary embodiment of the present invention.

As shown in FIG. 6, the status information transmitter 20 according to an exemplary embodiment of the present invention includes a first IF converter 21, a control information extractor 22, a second IF converter 23, a timing detector 24, a status information unit 25, and an RF converter 26.

The first IF converter 21 converts a downlink transmission signal transmitted through the optical transceiver 300 from a preset IF band signal to a baseband signal, and converts a baseband signal including status information of the radio unit into a preset IF band signal to transmit the preset IF band signal to the optical transceiver 300.

The first IF converter 21 may include an IF frequency oscillator, a frequency mixer, a band pass filter, and a low pass filter in order to down-convert the IF band signal into the baseband signal. The first IF converter 21 may further include a frequency mixer and a band pass filter in order to up-convert the baseband signal into an IF band signal.

The control information extractor 22 extracts a downlink transmission signal transmitted through an antenna and control information transmitted from a digital unit for control of the radio unit from the baseband signal output from the first IF converter 311.

The second IF converter 23 converts the downlink transmission signal from the control information extractor 22 into a preset IF band signal to transfer the preset IF band signal to the RF converter 26. The second IF converter 23 converts an uplink reception signal output from the RF converter 26 into a baseband signal to transfer the baseband signal to the timing detector 24 and the status information insertion unit 25.

The second IF converter 23 may include an IF frequency oscillator, a frequency mixer, and a band pass filter in order to uplink-convert the baseband signal into an IF band signal. The second IF converter 23 may further include a frequency mixer, a band pass filter, and a low pass filter in order to down-convert the IF band signal into the baseband signal.

Meanwhile, the timing detector 24 detects timing of a symbol for inserting status information of the radio unit from a signal provided from the second IF converter 23.

The status information insertion unit 25 inserts status information of the radio unit into a signal, that is, an uplink reception signal of the baseband provided from the second IF converter 23 using the timing information detected by the timing detector 24. The baseband signal with the status information on the radio unit is transferred to the first IF converter 21.

The RF converter 26 converts a downlink transmission signal provided from the second IF converter 23 into an RF band signal to transmit the RF band signal through the antenna. The RF converter 26 converts an uplink reception signal received through the antenna into the IF band signal to transmit the IF band signal to the second IF converter 23.

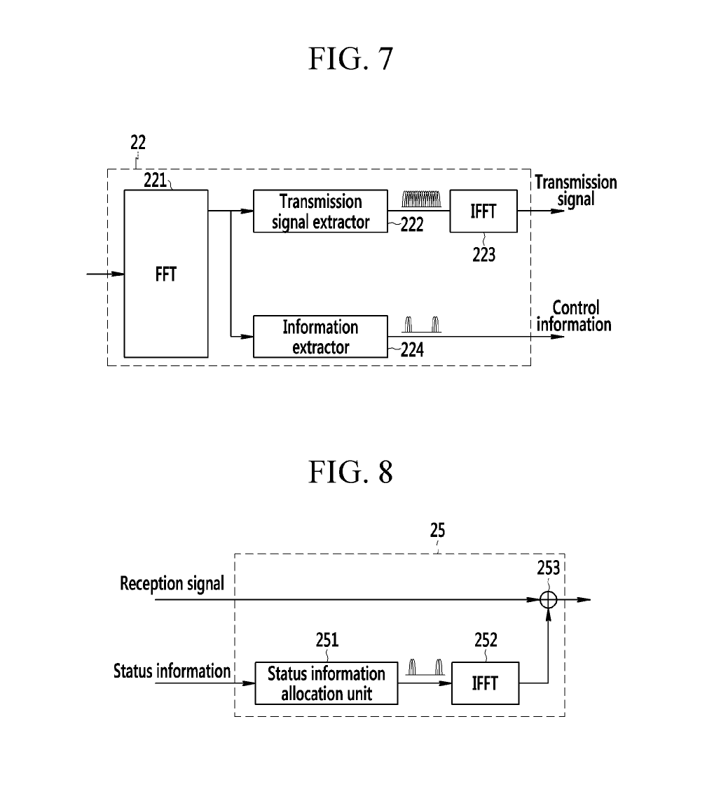

Meanwhile, the control information extractor 22 of the status information transmitter of the radio unit having the above configuration may have a configuration as illustrated in FIG. 7.

FIG. 7 is a block diagram a configuration of a control information extractor according to an exemplary embodiment of the present invention.

As shown in FIG. 7, the control information extractor 22 includes an FFT unit 221, a transmission signal extractor 222, an IFFT unit 223, and an information extractor 224.

The FFT unit 221 performs FFT with respect to a signal provided from the first IF converter 21. In this case, the FFT signal from the FFT unit 221 is provided to the transmission signal extractor 222 and the information extractor 224.

The transmission signal extractor 222 extracts a downlink transmission signal transmitted through the antenna from the preset sub-carrier. In this case, the signal extracted from the transmission signal extractor 222 is provided to the IFFT unit 223. Further, the transmission signal extractor 222 may extract a downlink transmission signal by inserting a “zero” value or a “null” value into a sub-carrier of a guard band to which the control information is allocated.

The IFFT unit 223 performs IFFT with respect to the signal provided from the transmission signal extractor 222. In this case, the IFFT signal from the IFFT unit 223 is provided to the second IF converter 23.

The information extractor 224 extracts control information inserted by the digital unit from the preset sub-carrier of a guard band in order to control the radio unit.

Meanwhile, the status information insertion unit 25 of the status information transmitter 20 in the radio unit may have a configuration as illustrated in FIG. 8.

FIG. 8 is a block diagram illustrating a configuration of a state information insertion unit according to an exemplary embodiment of the present invention.

As shown in FIG. 8, the status information insertion unit 25 includes a status information allocation unit 251, an IFFT unit 252, and an adder 253.

The status information allocation unit 251 allocates status information used to report a status of the radio unit to the digital unit to the sub-carrier of the guard band, and provides the allocation result to the IFFT unit 252.

The IFFT unit 252 performs IFFT with respect to the signal provided from the statue information allocation unit 251. In this case, the IFFT signal from the IFFT unit 252 is provided to the adder 253.

The adder 253 performs a superposition operation between an uplink reception signal received through the antenna and a signal output from the IFFT unit by sub-carriers. In this case, the signal received through the antenna corresponds to a signal of an IFFT time domain, and the signal superpositioned by the adder 253 is provided to the first IF converter 21.

Hereinafter, a method of transmitting control information and status information according to an exemplary embodiment of the present invention will be described based on an apparatus for transmitting control information and status information.

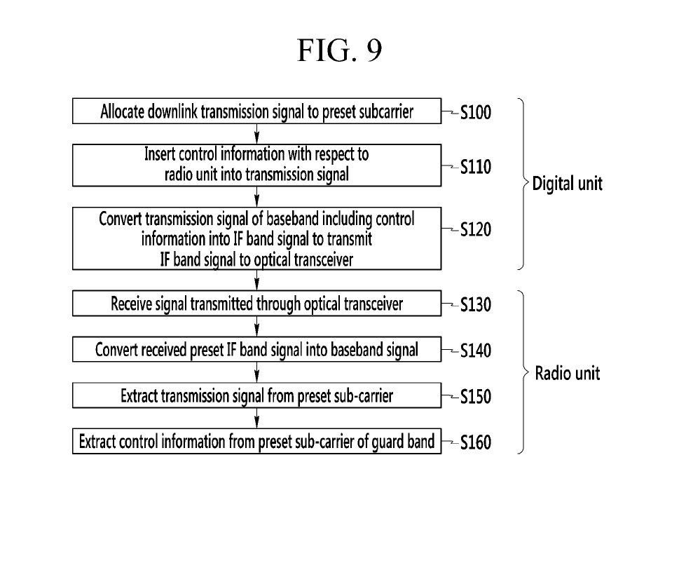

FIG. 9 is a flowchart illustrating a method of transmitting control information according to an exemplary embodiment of the present invention.

In order to transmit control information to the radio unit through the optical transceiver 300, a digital unit of the distributed base station according to an exemplary embodiment of the present invention allocates a downlink transmission signal to a preset sub-carrier (S100), and inserts control information with respect to the radio unit into the transmission signal (S110). That is, the digital unit of the distributed base station allocates the control information to a preset sub-carrier of a guard band, performs IFFT, and performs a superposition operation between a transmission signal to be transmitted through the antenna and the IFFT signal by sub-carriers.

Hereinafter, the digital unit converts a transmission signal of a baseband including control information into an IF band signal to transmit the IF band signal to the optical transceiver 300 (S120).

The optical transceiver 300 transmits the transmission signal to the radio unit, and the radio unit receives a signal transmitted through the optical transceiver 300 (S130) and converts the received preset IF band signal into a baseband signal (S140).

The radio unit extracts a downlink transmission signal transmitted through the antenna and control information transmitted from the digital unit for control of the radio unit from the baseband signal (S150 and S160). The radio unit extracts the downlink transmission signal transmitted through the antenna from a preset sub-carrier, and extracts control information from a preset sub-carrier of a guard band.

Hereinafter, the radio unit is operated based on the control information, and transmits currently maintained state information to the digital unit. Meanwhile, the downlink transmission signal is converted into an RF band signal and is transmitted through an antenna.

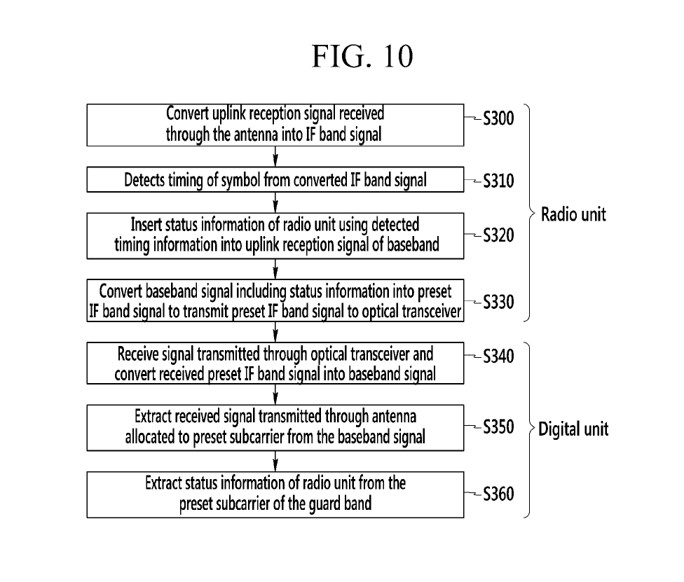

FIG. 10 is a flowchart illustrating a method of transmitting status information according to an exemplary embodiment of the present invention.

In order to transmit the status information to the digital unit through the optical transceiver 300, a radio unit of the distributed base station according to an exemplary embodiment of the present invention detects symbol timing when the state information is inserted from the uplink reception signal through the antenna. The radio unit of the distributed base station converts the uplink reception signal received through the antenna into an IF band signal, and detects timing of the symbol for inserting status information of the radio unit from the converted IF band signal (S300 and S310).

The radio unit inserts the status information of the radio unit using the detected timing information into an uplink reception signal of a baseband (S320). That is, the radio unit allocates status information used to report a status of the radio unit to a sub-carrier of a guard band and performs IFFT, and performs a superposition operation between an uplink reception signal received through the antenna and an IFFT signal by sub-carriers.

Hereinafter, the radio unit converts the baseband signal including the status information into a preset IF band signal to transmit the preset IF band signal to the optical transceiver 300 (S330).

The optical transceiver 300 transmits the signal to the digital unit, and the digital unit receives the signal transmitted through the optical transceiver 300 and converts the received preset IF band signal into a baseband signal to output the baseband signal (S340).

The digital unit extracts an uplink reception signal received through an antenna allocated to a preset sub-carrier from the baseband signal. Further, the digital unit extracts the status information of the radio unit from the preset sub-carrier of the guard band (S350 and S360).

In accordance with an exemplary embodiment of the present invention, control information and status information may be inserted and extracted between the digital unit and the radio unit of the distributed base station which are connected to each other based on a Radio over Fiber (RoF) through a guard-band which is not used to transmit a transmission/reception signal to a downlink or an uplink at a baseband.

Accordingly, compared with a method of transmitting control information or status information using a separate band, unnecessary resource consumption may be prevented.

The exemplary embodiment of the present invention described above is implemented not only by an apparatus and a method, but also by a program realizing a function corresponding to a configuration of the exemplary embodiment of the present invention or a recording medium recording the program. The above implementation may be achieved by a person of ordinary skill in the art based on the description of the above embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting control information by a distributed base station where a digital unit and a radio unit transmit/receive a signal through an optical transceiver, the method comprising:
inserting control information for controlling the radio unit into a guard band of a downlink transmission signal to be transmitted through an antenna by the digital unit; and
transmitting the downlink transmission signal including the control information to the radio unit through the optical transceiver by the digital unit.

2. The method of claim 1, wherein the inserting of the control information comprises:
allocating the control information to a preset sub-carrier of a guard band of the downlink transmission signal to process inverse fast Fourier transform (IFFT); and
performing a superposition operation between the IFFT processed signal and the downlink transmission signal by sub-carriers.

3. The method of claim 1, further comprising:
receiving the downlink transmission signal including the control information through the optical transceiver by the radio unit; and
extracting the control information of the guard band from the received downlink transmission signal.

4. The method of claim 1, wherein the digital unit and the radio unit transmit/receive an intermediate frequency (IF) band signal through the optical transceiver, and are connected to each other based on Radio over Fiber (RoF).

5. A method of transmitting status information by a distributed base station where a digital unit and a radio unit transmit/receive a signal through an optical transceiver, the method comprising:
inserting status information on the radio unit into a guard band of a uplink reception signal to be received through an antenna by the radio unit; and
transmitting the uplink reception signal including the status information to the digital unit through the optical transceiver.

6. The method of claim 5, wherein the inserting of the status information comprises:
detecting symbol timing from the uplink reception signal;
allocating status information to a preset sub-carrier of a guard band of the uplink reception signal based on the symbol timing to process IFFT; and
performing a superposition operation between the IFFT processed signal and the uplink reception signal by sub-carriers.

7. The method of claim 5, further comprising:
receiving the uplink reception signal including the status information through the optical transceiver; and
extracting the status information of the guard band from the received uplink signal.

8. The method of claim 5, wherein the radio unit and the digital unit transmit/receive an intermediate frequency (IF) band signal through the optical transceiver, and are connected to each other based on Radio over Fiber (RoF).

9. An apparatus for transmitting control information by a distributed base station where a digital unit and a radio unit transmit/receive a signal through an optical transceiver, the apparatus comprising:
a control information insertion unit configured to insert control information for controlling the radio unit into a preset sub-carrier of a guard band of a downlink transmission signal to be transmitted through an antenna; and
an IF converter configured to convert the downlink transmission signal including the control information to an IF signal and to transmit it to the radio unit through the optical transceiver.

10. The apparatus of claim 9, wherein the control information insertion unit comprises:
a control information allocation unit configured to allocate the control information to a preset sub-carrier of the guard band of the downlink transmission signal;
an IFFT unit configured to process inverse fast Fourier transform (IFFT) for a signal to which the control information is allocated; and
an adder which performs a superposition operation between the IFFT processed signal and the downlink transmission signal by sub-carriers to output the superposition result to the IF converter.

11. The apparatus of claim 9, wherein
the IF converter converts the IF band signal received from the optical transceiver into a baseband signal to output the baseband signal, and
the apparatus further comprises a status information extractor configured to extract status information on the radio unit from a guard band of a baseband output from the IF converter.

12. The apparatus of claim 11, wherein the status information extractor comprises:
a fast Fourier transform (FFT) unit configured to process FFT with respect to the baseband signal output from the IF converter;
a received signal extractor configured to extract an uplink reception signal from the FFT processed signal; and
an information extractor configured to extract the status information from the guard band of the FFT processed signal.

13. The apparatus of claim 9, wherein the apparatus for transmitting control information is included in the digital unit.

14. An apparatus for transmitting status information by a distributed base station where a digital unit and a radio unit transmit/receive a signal through an optical transceiver, the apparatus comprising:
a radio frequency (RF) converter configured to process and output an uplink reception signal received through an antenna;
a status information insertion unit configured to insert status information on the radio unit into a preset sub-carrier of a guard band of an uplink reception signal in the RF converter; and
a first intermediate frequency (IF) converter configured to convert the uplink reception signal including the status information into an IF band signal.

15. The apparatus of claim 14, further comprising:
a second IF converter which converts an uplink reception signal of an IF band output from the RF converter into a baseband signal to output the baseband signal; and
a timing detector configured to detect symbol timing from the baseband signal output from the second IF converter,
wherein the status information insertion unit inserts the status information into a preset sub-carrier of a guard band of the baseband signal output from the second IF converter according to the detected symbol timing.

16. The apparatus of claim 15, wherein the status information insertion unit comprises:
a status information allocation unit configured to allocate the status information to a preset sub-carrier of a guard band of the baseband signal output from the second IF converter;
an inverse fast Fourier transform (IFFT) unit to process IFFT with respect to a signal to which the status information is allocated; and
an adder which overlaps the IFFT processed signal with the uplink reception signal of a baseband signal output from the second IF converter by sub-carriers to output the overlapping result to the first IF converter.

17. The apparatus of claim 14, further comprising
a control information extractor configured to extract control information of the radio unit from a downlink transmission signal received through the optical transceiver,
wherein the first IF converter converts a downlink transmission signal of an IF band received from the optical transceiver into a baseband signal to transmit the baseband signal to the control information extractor, and the second IF converter converts a downlink transmission signal from which the control information is extracted by the control information extractor into an IF band signal to transmit the IF band signal to the RF converter.

18. The apparatus of claim 17, wherein the control information extractor comprises:
a fast Fourier transform (FFT) unit configured to process FFT with respect to the baseband signal output from the first IF converter;
a transmission signal extractor configured to extract a downlink transmission signal from the FFT processed signal; and
an information extractor configured to extract the control information from the guard band of the FFT processed signal.

19. The apparatus of claim 14, wherein the apparatus for transmitting status information is included in the radio unit.
